(19) United States
(12) Patent Application Publication
(10) Pub. No.: US 2009/0277957 A1
(43) Pub. Date: Nov. 12, 2009

(54) TIME STAMP MACHINE AND METHOD FOR CHECKING ATTENDANCE USING THE SAME

(75) Inventor: Zhi-Peng Ma, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/436,094

(22) Filed: May 5, 2009

(30) Foreign Application Priority Data
May 12, 2008 (CN) 200810301544.6

(51) Int. Cl. G06K 7/01

(52) U.S. Cl. 235/377

(57) ABSTRACT

A time stamp machine includes a reading unit, a recording unit, a comparing unit and a reminding unit. The reading unit reads unique identification codes when the time cards are clocked. The recording unit records the read identification codes and times when the identification codes are read. The comparing unit compares the information recorded by the recording unit with users information, which comprises identification codes and at least one of phone numbers and E-mail addresses stored in a memory connecting with the time stamp machine to find the time cards that have not been clocked between a predetermined schedule when current time reach a pre-set time. The reminding unit transmits reminding information to communication terminals corresponding to the time cards that have not been clocked between the predetermined schedule.

### BACKGROUND

1. Technical Field

The present disclosure relates to time stamp machines and methods for checking attendance using the time stamp machines.

2. Description of Related Art

Attendance machines are widely used in companies for checking time-in and time-out of employees. Commonly, the attendance machines are arranged at entrances, the employee can clock-in and clock-out via the attendance machines. However, some employees often forget to clock in or out.

Therefore, an attendance machine capable of reminding employees to clock in or out is desired. Thus, there is room for improvement within the art.

### BRIEF DESCRIPTION OF THE DRAWINGS

FIG. 1 is a schematic system for checking attendance in accordance with an exemplary embodiment.

FIG. 2 is a block diagram of the system for checking attendance in FIG. 1.

FIG. 3 is a flowchart of a method for checking attendance in accordance with an exemplary embodiment.

### DETAILED DESCRIPTION

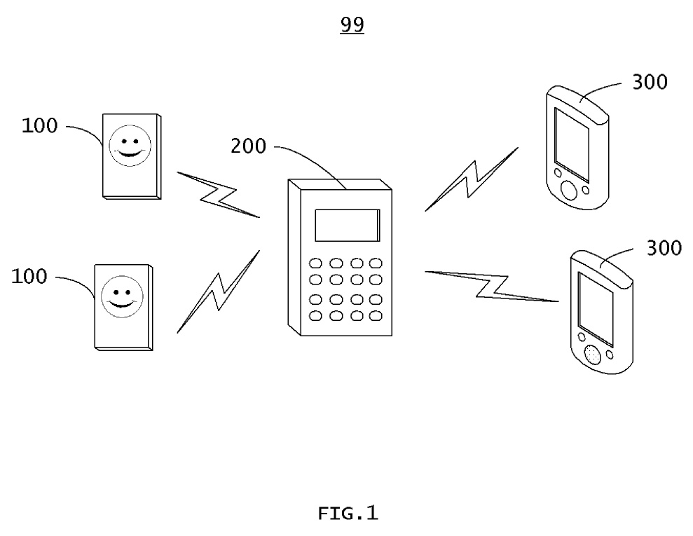

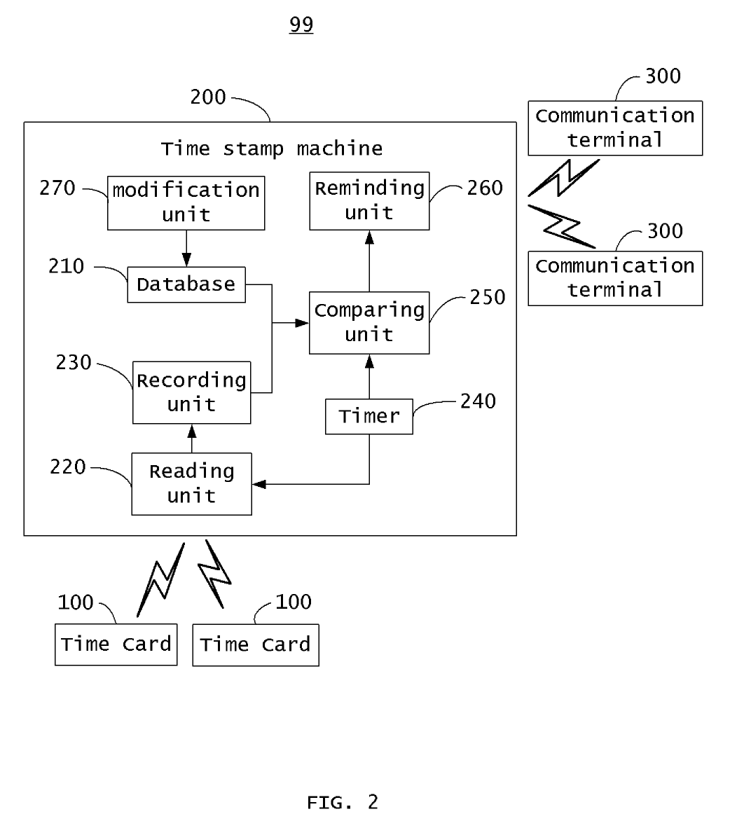

Referring to FIGS. 1 and 2, a system 99 for checking attendance includes a time stamp machine 200, a plurality of time cards 100, and a plurality of communication terminals 300 capable of communicating with the time stamp machine 200. The communication terminals 300 may be mobile phones, landline telephones or computers.

The time cards 100 are used for identifying users of the time cards 100. The users may be employees, students and so on. Each time card 100 has a unique identification code. The time cards 100 may be punch-in cards or digital cards.

The time stamp machine 200 is used for identifying the time cards 100. The time stamp machine 200 includes a database 210, a reading unit 220, a recording unit 230, a timer 240 capable of providing date/time information, a comparing unit 250, a reminding unit 260, and a modification unit 270.

The database 210 is used for storing user information corresponding to the time cards 100. The user information includes the identification codes, corresponding user names, phone numbers, and E-mail addresses and so on. The user information stored in the database 210 is modifiable via the modification unit 270.

The reading unit 220 is used for reading the identification codes of the time cards 100. The reading unit 220 may be a scanner capable of scanning the identification codes of the time cards 100.

The recording unit 230 is used for recording the identification codes read from the time cards 100 and the time when the identification codes are read (clock in/clock out time) are provided by the timer 240.

The timer 240 is also used for generating a check database signal and transmitting the check database signal to the comparing unit 250 when a current time reach a pre-set time. For example, the pre-set time is 8:00AM.

The comparing unit 250 is used for comparing the information recorded in the recording unit 230 with the user information stored in the database 210, so as to identify whether or not all time cards have been clocked according to a predetermined schedule. For example, the predetermined schedule may be from 6:00AM to 8:00AM Monday-Friday.

The reminding unit 260 is used for transmitting reminding information to the communication terminals corresponding to the time cards 100 that have not been clocked between the predetermined schedule to remind the users to clock their time cards 100. The reminding information may be text information or speech information or both, such as Emails.

In other embodiment, the database 210 and the modification unit 270 may be built out of the time stamp machine 200 and connected to the time stamp machine 200.

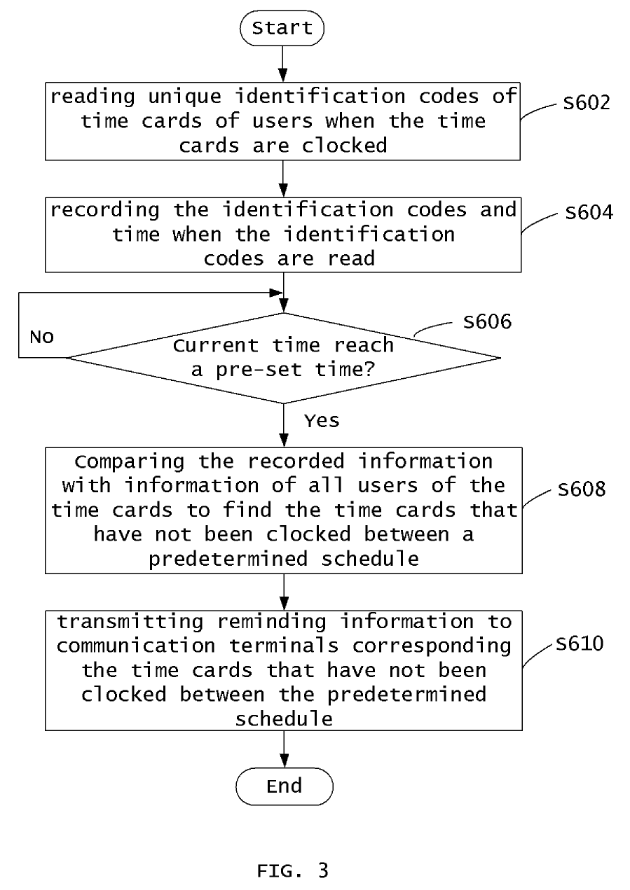

Referring to FIG. 3, a flowchart of a method for checking attendance in accordance with an exemplary embodiment is shown. The method may include the following steps.

In step S602, reading time cards to receive unique identification codes corresponding to the time cards for identifying users of the time cards.

In step S604, recording the read identification codes and times when the identification codes are read.

In step S606, judging whether current time reach a pre-set time. When the current time reaches the pre-set time, step S608 is implemented. When the current time does not reach the pre-set time, step S606 is implemented. The pre-set time may be 8:00AM.

In step S608, comparing the recorded information with information of users of the time cards to find the time cards that has not been clocked between a predetermined schedule. The user information may be stored in a memory and modifiable. The user information may include the unique identification codes of the time cards, corresponding user names, phone numbers, and E-mail addresses and so on. The predetermined schedule may be from 6:00AM to 8:00AM Monday-Friday.

In step S610, transmitting reminding information to communication terminals corresponding to the time cards that have not been clocked between the predetermined schedule, to remind the users to clock their time cards. The reminding information may be text information or speech information or both.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A time stamp machine comprising:
a reading unit reading unique identification codes of time cards when the time cards are clocked;
a recording unit recording the identification codes read by the reading unit and times when the identification codes are read;
a database storing pre-set information which comprises identification codes of the time cards, and at least one of phone numbers and E-mail addresses;
a comparing unit comparing information recorded in the recording unit with the pre-set information stored in the database to identify whether or not all time cards have been clocked according to a predetermined schedule, when the current time reach a pre-set time; and
a reminding unit transmitting reminding information to the communication terminals corresponding to the time cards that has not been clocked between the predetermined schedule to remind the users to clock their time cards.

2. The time stamp machine according to claim 1, further comprising a modification unit for modifying the information stored in the database.

3. The time stamp machine according to claim 1, wherein the reminding information is at least one of text information and speech information.

4. The time stamp machine according to claim 1, further comprising a timer for providing time information, wherein the timer generates a check database signal when the current time reach the pre-set time, then the comparing unit compares information recorded in the recording unit with the information stored in the database responding to the check database signal.

5. The time stamp machine according to claim 1, wherein the pre-set time is 8:00AM.

6. The time stamp machine according to claim 1, wherein predetermined schedule is from 6:00AM to 8:00AM Monday-Friday.

7. A method for checking attendance comprising:
reading identification codes of time cards of users when the time cards are clocked;
recording the read identification codes and times when the identification codes are read;
judging whether the current time reach a pre-set time;
comparing the recorded information with information of users of the time cards, which comprises unique identification codes and at least one of phone numbers and E-mail addresses correspondingly, to find the time cards that have not been clocked between a predetermined schedule when the current time reaches the pre-set time; and
transmitting reminding information to communication terminals corresponding to the time cards that have not been clocked between the predetermined schedule.

8. The method according to claim 7, further comprising:
returning to the step judging whether current time reach the pre-set time when the current time does not reach the pre-set time.

9. The method according to claim 7, wherein reminding information is at least one of text information and speech information.

10. The method according to claim 7, wherein the all user information is modifiable.

11. A time stamp machine comprising:
a reading unit reading unique identification codes when the time cards are clocked;
a recording unit recording the read identification codes and times when the identification codes are read;
a comparing unit comparing the information recorded by the recording unit with users information, which comprises identification codes and at least one of phone numbers and E-mail addresses stored in a memory connecting with the time stamp machine to find the time cards that have not been clocked between a predetermined schedule when current time reach a pre-set time; and
a reminding unit transmitting reminding information to communication terminals corresponding to the time cards that have not been clocked between the predetermined schedule.

12. The time stamp machine according to claim 11, wherein the reminding information is at least one of text information and speech information.

13. The time stamp machine according to claim 11, further comprising a timer, wherein the timer generates a check database when current time reach the pre-set time, then the comparing unit compares the information recorded by the recording unit with user information stored in the memory responding to the check database signal.

14. The time stamp machine according to claim 11, wherein user information stored in the memory can be modified.
